(19) United States
(12) Patent Application Publication
(10) Pub. No.: US 2001/0037232 A1
(43) Pub. Date: Nov. 1, 2001

(54) Method for tracking advertising effectiveness

(76) Inventor: Kenneth C. Miller, Aptos, CA (US)

Correspondence Address: Kenneth C. Miller, 402 West Seacliff Drive, Aptos, CA, 95003, US

(21) Appl. No.: 09/805,531

(22) Filed: Mar. 13, 2001

Related U.S. Application Data
(60) Provisional application No. 60/188,863, filed on Mar. 13, 2000.

(51) Int. Cl. G06F 17/60

(52) U.S. Cl. 705/10

(57) ABSTRACT

The present invention is a method for tracking advertising effectiveness by rewarding audience members for viewing and responding to advertisements. Incentive rewards are given to audience members who report which advertisements they see. Each time an audience member reports viewing an advertisement, the member is given credits that can be redeemed for something of value. The present invention provides useful feedback to advertisers about the effectiveness of their advertisements.

### CLAIM OF PRIORITY

This application claims priority from co-pending provisional application 60/188,863, filed Mar. 13, 2000.

### BACKGROUND OF THE INVENTION

1. Field of the Invention

This invention relates to a method for determining the effectiveness of advertising by feedback from audience members.

2. Description of the Relevant Art

Advertisers spend substantial funds on distributing their advertisements through various media, such as television, the Internet, billboards, and recordings, but with little if any feedback as to the effectiveness of their advertisements. Broadcast television, for example, has the Nielson rating system, which provides information about how many households or television sets are tuned to each broadcast channel, but this system does not really tell the advertisers whether the viewers are actually watching their ads or are ignoring them. Viewers typically would prefer not to pay attention to ads. In addition to traditional advertising, products are sometimes promoted by using them as props or background in movies or programs, but without any means to determine the effectiveness of the promotion.

What is needed is a method for tracking the actual viewing of advertisements or product placements by the audience so that advertisers can evaluate the effectiveness of their advertisements and product placements and can understand their audience better. What is further needed is a method for encouraging the audience to watch advertisements and to look for product placements in programs and movies.

### SUMMARY OF THE INVENTION

In summary, the present invention is a method for tracking advertising effectiveness by rewarding audience members for looking at or watching and responding to advertisements or product displays. Incentive rewards are given to audience members who report which advertisements or product displays they see. Each time an audience member reports looking at, viewing, or hearing an advertisement or product display, the member is given credits that can be redeemed for something of value. The present invention provides useful feedback to advertisers about the effectiveness of their advertisements and product displays.

In particular, the method for determining advertising effectiveness of the present invention, comprises the steps of: (1) displaying an advertisement or product to an audience; (2) indicating that the advertisement or product display seeks feedback responses from the audience; (3) receiving feedback responses from the audience; (4) crediting accounts for audience members who provide feedback responses; and (5) compiling the feedback responses to judge the effectiveness of the advertisement or product display.

The features and advantages described in the specification are not all inclusive, and particularly, many additional features and advantages will be apparent to one of ordinary skill in the art in view of the drawings, specification and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a flow chart of an implementation of the method for tracking advertising effectiveness of the present invention.

### DETAILED DESCRIPTION OF THE PREFERRED EMBODIMENTS

The following description depicts various preferred embodiments of the present invention for purposes of illustration only. One skilled in the art will readily recognize from the following discussion that alternative embodiments of the structures and methods illustrated herein may be employed without departing from the principles of the invention described herein.

The present invention is a method for tracking advertising effectiveness by rewarding viewers for watching and responding to ads and looking for displayed products. Viewers are encouraged to report which advertisements they see because they are given an incentive reward for reporting what they see. Each time a viewer reports that he or she has seen an advertisement or product display, the viewer is given credits that can be redeemed for something of value—i.e., goods or services. By offering this reward incentive, advertisers can obtain feedback from their audience as to who, what, when, and where viewers are watching their advertisements or product displays. This feedback information can be analyzed to show which advertisements or product displays are effective and which are not.

The incentive rewards can take a variety of forms, like frequent flyer miles, credit card points, redemption stamps and so on. The viewer can redeem the incentive rewards for products or services proportionate in value to the number of credits accumulated.

Advertisements can be displayed visually or audibly through many live or real-time media, including computers, telephone, television, billboards, radio, the Internet, etc. or through pre-recorded media, including tape, CDs, DVDs, etc. Broadly speaking, the advertisements subject to the present invention can include product placements, such as used in movies, television programs and the like, in which a product (or service) is depicted as a prop or background to a scene. The advertisements would have some indicia that indicate to the audience that it is enabled for this evaluation method, and therefore has the potential to reward the audience. This identification may be, for example, in the form of a visual indicator (such as a colored dot, icon, etc.) on a visual display or an audible indicator (such as a beep, tone, tune, etc.) sounded by a speaker or some other means.

Another aspect of the method is to provide a means through which the viewer can respond to an ad or product display to earn response credits. The response means can be, for example, a programmed computer, set-top box, home entertainment controller, game console, telephone (including cellular), or a special-purpose device, such as a hand-held device with a keypad or a speech-recognition device. The viewer inputs information into the response means by, for example, clicking on an icon or box on a computer screen or pressing keys on a hand-held device or keyboard, touching a touch-sensitive screen, or speaking into a microphone of a telephone or speech-recognition device. The response means identifies the viewer and correlates the ad in question with the viewer's response.

In the case of public advertisements, such as billboards, mobile ads, and the like, the response step may include verifying that the viewer has access to the advertisement by determining whether the viewer is present in the vicinity of the public advertisement. This verifying step can, for example, use a global-positioning system (GPS) or other locating device to locate the viewer and correlate it with a known location of the advertisement, or can require the viewer to input data, such as code information, viewable from the public advertisement.

This response step may involve or require input from the viewer beyond merely pressing a button, so that the advertiser has some reasonable assurance that the viewer is actually comprehending the ad and not thoughtlessly pressing buttons. This may include, for example, typing in or speaking the name of the advertiser or product or service advertised, responding to a multiple choice question presented by the response device, or clicking on an icon associated with the ad. Requiring a response that identifies the ad subject tends to reinforce product recognition by the viewers.

When a viewer sends a correct response to an enabled ad, the method may include a step of indicating that the viewer's input is correct and has been received. This acknowledgement could be in the form of a visual signal (such as a colored dot, icon, etc.) on a display or an audible signal (beep, tone, tune, etc.) from a speaker or some other means. The response means may also indicate to the viewer how many response credits have been accumulated. The amount of credit given to a response may vary according to the “correctness” of the response. For example, the method may award a minimal credit for a minimal response, but award more credits for correctly identifying the subject or advertiser, or for supplying demographic information about the viewer.

The method further includes a step of communicating the viewer's responses to a central location where the credit awards are accounted for (by updating the viewer's account) and where the responses of all viewers can be combined so that the effectiveness of the advertising can be analyzed. The viewer's responses may be uploaded to a data-gathering location either in real time or stored locally for batch processing later. For example, the response device could be a hand-held device that is used with television ads and then placed in a cradle that is connected to a computer (like a Palm personal assistant device) to upload the responses to the computer and then from the computer to the data gathering means.

Bonus awards could be given for further viewer encouragement, for example, for responding to a given number of ads in a row, all the ads in a particular program, a given number of ads in a given amount of time, etc.

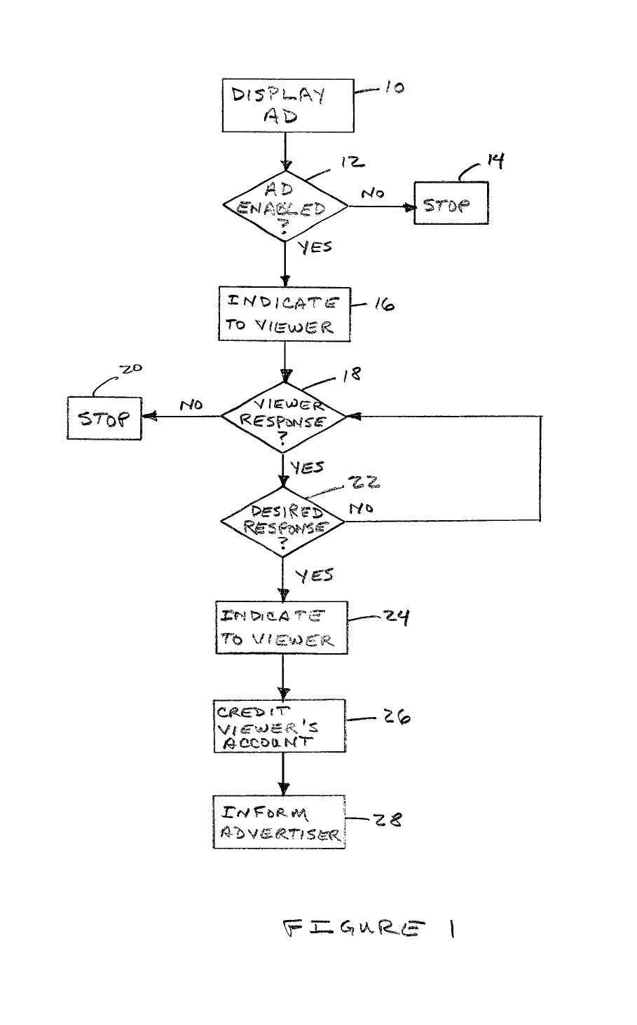

FIG. 1 illustrates one embodiment of the method of the present invention for use with a sequence of advertisements, such as in a television broadcast. An advertisement is displayed in step 10 and the method determines whether the ad is enabled for audience feedback in step 12. If not, the method stops (step 14) for this ad and resets for the next ad to be shown. If the ad is enabled, the method in step 16 indicates that the ad is enabled by, for example, displaying a visual indicator or sounding an audible indicator. The method then looks for a viewer response to the enabled ad in step 18. If there is no viewer response, then the method stops (step 20) and resets for the next ad. If there is a viewer response, then the method in step 22 decides whether the response is the desired or correct response, such as correctly naming the advertiser or the product or service advertised. If the response is incorrect, the method loops back to step 18 and looks for another response, and may also indicate to the viewer that the earlier response was incorrect. Minimal credit may be given for a response even though it is incorrect. If step 22 indicates that the viewer input the desired response, then the method indicates to the viewer that the response was correct in step 24, credits the viewer's account with the incentive reward in step 26, and informs the advertiser of the response in step 28. Other embodiments of the present invention are possible.

From the above description, it will be apparent that the invention disclosed herein provides a novel and advantageous method for tracking advertising effectiveness. The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A method for determining advertising effectiveness, comprising the steps of:
displaying an advertisement to an audience;
indicating to audience members that the advertisement seeks feedback responses from the audience;
receiving feedback responses from the audience;
crediting an account for each audience member who provides a feedback response, wherein accounts are credited with credits that are redeemable for something of value; and
compiling feedback from the audience to judge the effectiveness of the advertisement.

2. A method for determining advertising effectiveness as recited in claim 1 wherein the step of displaying an advertisement includes radio or television broadcasting the advertisement.

3. A method for determining advertising effectiveness as recited in claim 1 wherein the step of displaying an advertisement includes displaying the advertisement in computer-readable format.

4. A method for determining advertising effectiveness as recited in claim 1 wherein the step of displaying an advertisement includes incorporating the advertisement into pre-recorded media.

5. A method for determining advertising effectiveness as recited in claim 1 wherein the step of displaying an advertisement includes displaying the advertisement on a billboard.

6. A method for determining advertising effectiveness as recited in claim 1 wherein the step of indicating that the advertisement seeks feedback responses includes providing a visual indicator on a visual display.

7. A method for determining advertising effectiveness as recited in claim 1 wherein the step of indicating that the advertisement seeks feedback responses includes providing an audible indicator through a speaker.

8. A method for determining advertising effectiveness as recited in claim 1 wherein the step of receiving feedback responses from the audience includes receiving data from electronic devices operated by the audience.

9. A method for determining advertising effectiveness as recited in claim 8 wherein the data received includes information indicating whether the audience members comprehend the advertisement.

10. A method for determining advertising effectiveness as recited in claim 8 wherein the data received includes information identifying the advertisement.

11. A method for determining advertising effectiveness as recited in claim 1 further comprising a step of indicating to an audience member that a feedback response has been received from that audience member.

12. A method for determining advertising effectiveness as recited in claim 1 further comprising a step of indicating a credit balance to an audience member following receipt of a feedback response from that audience member.

13. A method for determining advertising effectiveness as recited in claim 1 wherein the step of crediting an account includes crediting additional credits for responding to multiple advertisements.

14. A method for determining advertising effectiveness as recited in claim 1 further comprising a step of verifying that audience members have access to the advertisement to which it is responding.

15. A method for determining advertising effectiveness, comprising the steps of:
displaying an advertisement to an audience;
indicating to audience members that the advertisement seeks feedback responses from the audience by providing a visual indicator on a visual display;
receiving feedback responses from the audience by receiving data from electronic devices operated by the audience, wherein the data includes information indicating whether the audience members comprehend the advertisement;
indicating to an audience member that a feedback response has been received;
crediting an account for each audience member who provides a feedback response, wherein accounts are credited with credits that are redeemable for something of value;
indicating a credit balance to an audience member following receipt of a feedback response from that audience member; and
compiling feedback from the audience to judge the effectiveness of the advertisement.
